(19) United States
(12) Patent Application Publication
(10) Pub. No.: US 2015/0049664 A1
(43) Pub. Date: Feb. 19, 2015

(54) Method for Controlling a Multi-Hop Transmission

(71) Applicants: Jacek Gora, Wroclaw (PL); Simone Redana, Munich (DE); Michael Faerber, Wolfratshausen (DE)

(72) Inventors: Jacek Gora, Wroclaw (PL); Simone Redana, Munich (DE); Michael Faerber, Wolfratshausen (DE)

(21) Appl. No.: 14/359,189

(22) PCT Filed: Oct. 13, 2011
(86) PCT No.: PCT/EP2011/067921

§ 371 Date: Aug. 13, 2014

(51) Int. Cl. H04W 40/22; H04L 12/733; H04W 28/02; H04L 12/727

(52) U.S. Cl. CPC H04W 40/22; H04L 45/121; H04L 45/20; H04W 28/0236
USPC 370/315

(57) ABSTRACT

Method for controlling a multi-hop transmission it is described a method for controlling a multi-hop transmission of a data packet between a base station and a user equipment via at least one relay node. A maximum allowable time period for transmitting the data packet between the base station and the user equipment via the at least one relay node is specified. The method includes calculating, based on a time information associated with a time period, which has been needed for a transmission of the data packet to the at least one relay node, and the maximum allowable time period, a remaining time period being available for the at least one relay node for transmitting the data packet, and controlling the transmission of the data packet from the at least one relay node to the base station or the user equipment based on the calculated remaining time period.

### FIELD OF THE INVENTION

The present invention relates to the field of communication networks and in particular to communication networks which provide a multi-hop transmission via one or more relay nodes.

### BACKGROUND OF THE INVENTION

In mobile wireless communication systems, such as the 3GPP Long Term Evolution (LTE, LTE-Advanced), systems may incorporate relaying techniques. Relaying based on dedicated nodes (relay node, RN) might be one of the key solutions in fourth generation (4G) systems (e.g. LTE-A, WMAX).

The LTE Rel. 10 standards define the so called two-hop architecture, i.e. with all relay nodes (RNs) connected directly to a donor eNodeB or base station (DeNB). More advanced concepts consider also multi-hop architectures, with RNs allowed to connect also to other RNs (nested-RN).

A multi-hop connection (two hops or more) might be burdened with additional transmission delay, compared to a direct connection. Each RN in a multi-hop connection adds delay (or transmission time) to an end-to-end packet transmission time. The delay comes from packet processing and scheduling times. If, as considered in today known LTE standards, scheduling is done at each RN independently, there are no means to control the total delay in transmission of a packet in each hop.

In view of the above-described situation, there exists a need for an improved technique that enables to provide a control of the total delay or transmission time. Hence, a system or method being able to provide an overall control of the transmission time may be needed.

### SUMMARY OF THE INVENTION

This need may be met by the subject matter according to the independent claims. Advantageous embodiments of the herein disclosed subject matter are described by the dependent claims.

According to a first aspect of the herein disclosed subject matter, there is provided a method for controlling a multi-hop transmission of a data packet between a base station and a user equipment via at least one relay node. According to this method, a maximum allowable time period for transmitting the data packet between the base station and the user equipment via the at least one relay node is specified. The method comprises calculating, based on a time information associated with a time period, which has been needed for a transmission of the data packet to the at least one relay node, and the maximum allowable time period, a remaining time period being available for the at least one relay node for transmitting the data packet, and controlling the transmission of the data packet from the at least one relay node to the base station or the user equipment based on the calculated remaining time period.

As already explained above, networks, in particular cellular network according to LTE standards, may be arranged by using one or more relay nodes (RNs). A RN is a base station not having a fixed connection to the operator's core network (backhaul). The backhaul connection is provided to them over radio interface from a standalone (i.e. having a fixed backhaul) base station (donor node, DeNB). The RN can be either a stationary device (e.g. installed on a lamppost), or a mobile device (e.g. installed in a bus, train). The basic use case for RNs is providing low cost network coverage extension and coverage improvement in areas not suitable for typical base station deployments (e.g. due to cost and/or difficulties of providing fixed backhaul).

In such a network structure, a communication from a base station to a user equipment may be established via one or more RNs. As mentioned, such a multi-hop connection (two hops or more) might be burdened with additional transmission delay compared to a direct connection. Each RN in a multi-hop connection may add delay to an end-to-end packet transmission time. The delay comes, for instance, from packet processing and scheduling times. If, as considered in LTE standards, scheduling is done at each RN independently, there are no means to control the total delay in transmission of a packet in each hop.

For data packets used in a communication, different quality of service (QoS) requirements may be specified. Each transmitted packet may be assigned with QoS requirements corresponding to the service for which the packet is corresponding to. For instance, there may be nine classes of QoS, identified in the packet by the QoS class identifier (QCI). The QCI defines setting for the packet delay budget (PDB). Packet delays—in particular for guaranteed bit rate (GBR) traffic—should typically be lower than the PDB specified for a QCI as long as the UE has sufficient radio channel quality (see 3GPP23.203). In average 20 ms delay may be assumed in the core network (between base station and policy and charging enforcement functionality (PCEF)). PDB minus the core network delay may be the maximum delay applicable for the radio interface.

For a multi-hop connection, to correctly estimate the delay allowed on a hop of the connection (at the DeNB, nested-RN or an end-RN), it may be required to know the delay already used at earlier hops, for example at the DeNB or an earlier RN, the number of further RNs in the connection and the delay that the following RNs might introduce. With the standards existing so far, there is no possibility for a RN to know the delay already used. Further, the knowledge of the further RNs in the connection cannot be always assumed (depends on the architecture).

If, as considered in existing LTE standards, scheduling is done at each relay independently, there are no means to control the total delay in transmission of a packet in each hop. Existing delay budget control may work fine for a direct base station to user equipment connection, but not for a multi-hop (two-hop and more) connection.

Hence, the basic idea of the present invention is to provide a method being able to control delay budget for a multi-hop communication or connection.

According to this method, a multi-hop transmission of a data packet between a base station and a user equipment via at least one relay node may be controlled. A maximum allowable time period for transmitting the data packet between the base station and the user equipment via the at least one relay node may be specified. The method comprises calculating, based on a time information associated with a time period, which has been needed for a transmission of the data packet to the at least one relay node, and the maximum allowable time period, a remaining time period being available for the at least one relay node for transmitting the data packet, and controlling the transmission of the data packet from the at least one relay node to the base station or the user equipment based on the calculated remaining time period.

A relay node according to this embodiment may be a base station not having a fixed connection to the operator's core network (backhaul). The backhaul connection may be provided to them over radio interface from a standalone (i.e. having a fixed backhaul) base station (donor node, DeNB). The RN can be either a stationary device (e.g. installed on a lamppost), or a mobile device (e.g. installed in a bus, train). The basic use case for RNs is providing low cost network coverage extension and coverage improvement in areas not suitable for typical base station deployments (e.g. due to cost and/or difficulties of providing fixed backhaul).

The base station may be any kind of base station or eNodeB being able to provide the above mentioned functionalities. The user equipment may be a regular LTE device being able to communicate with the base station via the relay node.

The control of the transmission of the data packet may be based on a remaining time period. A maximum allowed time period for the transmission of the data packet (from the base station to the user equipment or vice versa) may be specified. The remaining time period (remaining for the further transmission) may be calculated based on the maximum (total) transmission time period and the transmission time already needed.

According to an embodiment of the invention, calculating the remaining time period being available for the at least one relay node for transmitting the data packet is further based on a time information associated with a predicted time period, which will be needed for a transmission of the data packet starting from the at least one relay node.

The relay node may determine the transmission time already used and the transmission time which will be needed for the further hops. Based on this information, the relay node may calculate the transmission time which the relay node is allowed to use for the next hop.

According to a further embodiment of the invention, the maximum allowable time period for transmitting the data packet between the base station and the user equipment via the at least one relay node is specified based on quality of service requirements.

As mentioned above, different quality of service (QoS) requirements may be specified to be fulfilled for a communication between a user equipment and a base station. The QoS requirements may be specified per communication or per data packet or a plurality of data packets. The QoS requirements may be associated with a specific kind of communication, like voice or video transmission, and may related to a quality of the transmission or time requirements.

According to a further embodiment of the invention, controlling the transmission of the data packet from the at least one relay node to the base station or the user equipment comprises estimating a needed time period for transmitting the data packet to the base station or the user equipment, and determining whether the needed time period is less than or equal to the calculated remaining time period.

If the needed time period is less or equal to the calculated remaining time period, the RN may forward the data packet to the next hop (next RN or final destination, i.e. user equipment or base station).

According to a further embodiment of the invention, controlling the transmission of the data packet from the at least one relay node to the base station or the user equipment comprises dropping the data packet when the needed time period is greater than the calculated remaining time period.

If the needed time period is greater than the calculated remaining time period, the RN may decide to drop the data packet. In this case, the RN may send a message to the start point, i.e. the user equipment or the base station, and request re-transmission of the data packet. In a further embodiment, the RN node may decide to use a different path for transmission than the path for which the needed time period has been estimated.

According to a further embodiment of the invention, the method further comprises determining the time information associated with a time period, which has been needed for transmission of the data packet to the at least one relay node, based on a timestamp being comprised in the data packet.

Each packet may be marked with a timestamp showing for example the generation time of the packet. The timestamp may be added to a header of the generated packet.

According to a further embodiment of the invention, the timestamp is indicative of a generation time of the data packet, and determining the time information comprises comparing the timestamp with an actual time, and calculating the time period, which has been needed for transmission of the data packet to the at least one relay node based on this comparison.

Each node, upon reception of a packet, may check the timestamp in the packet header, compare it with the current time and estimate the already experienced delay. If it determines that the remaining time for transmission is not sufficient to deliver the packet within the QoS requirements, the packet may be dropped, if not then it may transmit the packet onto the next hop.

According to a further embodiment of the invention, the method further comprises determining a predicted time period, which will be needed for transmission of the data packet starting from the at least one relay node, based on overall network information being provided to the relay node during start of the relay node, wherein calculating the remaining time period being available for the at least one relay node for transmitting the data packet is further based on a time information associated with the predicted time period.

According to this embodiment, at each stage of the multi-hop connection, i.e. at each RN along the path, the RN may know how many relaying hops are still coming. This may allow estimating what fraction of the remaining time period can be used for each relaying hop. The knowledge of number of relaying hops in a multi-hop connection can be assumed according to the following. For downlink user-terminated transmissions, the DeNB may have a lookup table, in which a target Cell ID is associated with a number of hops required to reach a UE at the indicated RN cell. This information could be provided by the RN during the RN start up procedure (the RN receives this information from the RN-OAM (operation and maintenance system). For uplink DeNB-terminated transmissions, each RN may know the number of hops required to reach a DeNB, e.g. based on information provided from RN-OAM during RN start up procedure. The number of remaining hops can be included in the packet and decreased at each intermediate node that is passed. Thus, knowing the real past delay and next relaying hops precise control of the packet scheduling delay can be done.

According to a further embodiment of the invention, the method further comprises determining the time information associated with a time period, which has been needed for transmission of the data packet to the at least one relay node, based on predetermined transmission time information being exchanged between the at least one relay node and the base station.

The predetermined transmission time information may be based on standard defined layer 2 packet delay measurement mechanisms (for example as defined in TS 36.314). In such measurements, a base station measures the packet delay for each packet QCI (QoS class identifier). The measurements are done for downlink and uplink transmission directions. These measurements may then be exchanged between interconnected nodes (i.e. between relay nodes and base stations). The information on packet delay on previous and next relaying hops may be used to correctly estimate the maximum delay budget available for the current relaying hop.

According to a further embodiment of the invention, the method further comprises determining a predicted time period, which will be needed for a transmission of the data packet starting from the at least one relay node, based on a predetermined transmission time information being exchanged between the at least one relay node and the base station, wherein calculating the remaining time period being available for the at least one relay node for transmitting the data packet is further based on a time information associated with the predicted time period.

As explained above, the relay node may determine the transmission time already used and the transmission time which will be needed for the further hops. Based on this information, the relay node may calculate the transmission time which the relay node is allowed to use for the next hop.

According to a further embodiment of the invention, determining the time information associated with a time period, which has been needed for a transmission of the data packet to the at least one relay node, and/or determining the predicted time period comprises exchanging packet delay measurements between the base station and the at least one relay node.

The measurements may be done for downlink and uplink transmission directions. These measurements may then be exchanged, for example via signalling, between interconnected nodes (i.e. between relay nodes and base stations).

According to a further embodiment of the invention, exchanging packet delay measurements comprises exchanging information via an X2 interface. Any kind of node may comprise an X2 interface for communicating with interconnect nodes.

According to a further embodiment of the invention, exchanging packet delay measurements comprises exchanging information using radio resource control (RRC) signalling and/or medium access control (MAC) signalling.

The measurements be exchanged via RRC or MAC signalling, between interconnected nodes (i.e. between relay nodes and base stations). The information on packet delay on previous and next relaying hops can be used to correctly estimate the maximum delay budget available for the current relaying hop. If it is determined that the remaining time for transmission is not sufficient to deliver the packet within the QoS requirements, the packet can be dropped if not then the RN may transmit the packet onto the next hop.

According to a second aspect of the invention, a relay node is provided, wherein the relay node is adapted for controlling a multi-hop transmission of a data packet between a base station and a user equipment via the at least one relay node, wherein a maximum allowable time period for transmitting the data packet between the base station and the user equipment via the at least one relay node is specified, the relay node comprising a calculation unit being adapted to calculate, based on a time information associated with a time period, which has been needed for a transmission of the data packet to the at least one relay node, and the maximum allowable time period, a remaining time period being available for the at least one relay node for transmitting the data packet, and a control unit for controlling the transmission of the data packet from the at least one relay node to the base station or the user equipment based on the calculated remaining time period.

A relay node according to this embodiment may be a base station not having a fixed connection to the operator's core network (backhaul). The backhaul connection may be provided to them over radio interface from a standalone (i.e. having a fixed backhaul) base station (donor node, DeNB). The RN can be either a stationary device (e.g. installed on a lamppost), or a mobile device (e.g. installed in a bus, train). The basic use case for RNs is providing low cost network coverage extension and coverage improvement in areas not suitable for typical base station deployments (e.g. due to cost and/or difficulties of providing fixed backhaul).

The relay node may comprise a receiving unit, for example a receiver as known by a skilled person. The relay node may also comprise a transmitting unit, for example a transmitter. The receiver and the transmitter may be implemented as one single unit, for example as a transceiver. The transceiver or the receiving unit and the transmitting unit may be adapted to communicate with a further relay node, a base station or the user equipment via an antenna.

The control unit and the calculation unit may be implemented as single units or may be one unit being implemented for example as part of a standard control unit, like a CPU or a microcontroller.

The base station may be any type of access point or point of attachment, which is capable of providing a wireless access to a cellular network system. Thereby, the wireless access may be provided for a user equipment or for any other network element, which is capable of communicating in a wireless manner. The base station may be an eNodeB, eNB, home NodeB or HNB, or any other kind of access point.

The base station may comprise a receiving unit, for example a receiver as known by a skilled person. The base station may also comprise a transmitting unit, for example a transmitter. The receiver and the transmitter may be implemented as one single unit, for example as a transceiver. The transceiver or the receiving unit and the transmitting unit may be adapted to communicate with the relay node via an antenna.

A user equipment (UE) in the context of this description may be any type of communication end device, which is capable of connecting with the described relay node. The UE may be in particular a cellular mobile phone, a Personal Digital Assistant (PDA), a notebook computer, a printer and/or any other movable communication device.

The user equipment may comprise a receiving unit or receiver which is adapted for receiving signals from the relay node.

The user equipment may further comprise a transmitting unit for transmitting signal. The transmitting unit may be a transmitter as known by a skilled person. The receiver and the transmitting unit may be implemented as one single unit, for example as a transceiver. The transceiver or the receiver and the transmitting unit may be adapted to communicate with the relay node via an antenna.

According to a third aspect of the invention, a network system for controlling a multi-hop transmission of a data packet between a base station and a user equipment via at least one relay node is provided, wherein the network system comprises a least one relay node as described above.

Generally herein, the method and embodiments of the method according to the first aspect may include performing one or more functions described with regard to the second or third aspect or an embodiment thereof. Vice versa, the relay node or network system and embodiments thereof according to the second and third aspect may include units or devices for performing one or more functions described with regard to the first aspect or an embodiment thereof.

According to a fourth aspect of the herein disclosed subject-matter, a computer program for controlling a multi-hop transmission, is provided, the computer program being adapted for, when executed by a data processor assembly, controlling the method as set forth in the first aspect or an embodiment thereof.

As used herein, reference to a computer program is intended to be equivalent to a reference to a program element and/or a computer readable medium containing instructions for controlling a computer system to coordinate the performance of the above described method.

The computer program may be implemented as computer readable instruction code by use of any suitable programming language, such as, for example, JAVA, C++, and may be stored on a computer-readable medium (removable disk, volatile or non-volatile memory, embedded memory/processor, etc.). The instruction code is operable to program a computer or any other programmable device to carry out the intended functions. The computer program may be available from a network, such as the World Wide Web, from which it may be downloaded.

The herein disclosed subject matter may be realized by means of a computer program respectively software. However, the herein disclosed subject matter may also be realized by means of one or more specific electronic circuits respectively hardware. Furthermore, the herein disclosed subject matter may also be realized in a hybrid form, i.e. in a combination of software modules and hardware modules.

In the above there have been described and in the following there will be described exemplary embodiments of the subject matter disclosed herein with reference to a network system, a relay node and a method of controlling a multi-hop transmission. It has to be pointed out that of course any combination of features relating to different aspects of the herein disclosed subject matter is also possible. In particular, some embodiments have been described with reference to apparatus type embodiments whereas other embodiments have been described with reference to method type embodiments. However, a person skilled in the art will gather from the above and the following description that, unless other notified, in addition to any combination of features belonging to one aspect also any combination between features relating to different aspects or embodiments, for example even between features of the apparatus type embodiments and features of the method type embodiments is considered to be disclosed with this application.

The aspects and embodiments defined above and further aspects and embodiments of the present invention are apparent from the examples to be described hereinafter and are explained with reference to the drawings, but to which the invention is not limited.

### BRIEF DESCRIPTION OF THE DRAWINGS

FIG. 1 shows a network system according to an exemplary embodiment of the invention.

FIG. 2 shows a network system according to a further exemplary embodiment of the invention.

FIG. 3 shows a network system according to a further exemplary embodiment of the invention.

FIG. 4 shows a network system according to a further exemplary embodiment of the invention.

FIG. 5 shows a base station, a relay node and a user equipment within a network system according to an exemplary embodiment of the invention.

### DETAILED DESCRIPTION

The illustration in the drawing is schematically. It is noted that in different figures, similar or identical elements are provided with the same reference signs.

In the following, embodiments of the herein disclosed subject matter are illustrated with reference to the drawings and reference to aspects of current standards, such as LTE. However, such reference to current standards is only exemplary and should not be considered as limiting the scope of the claims.

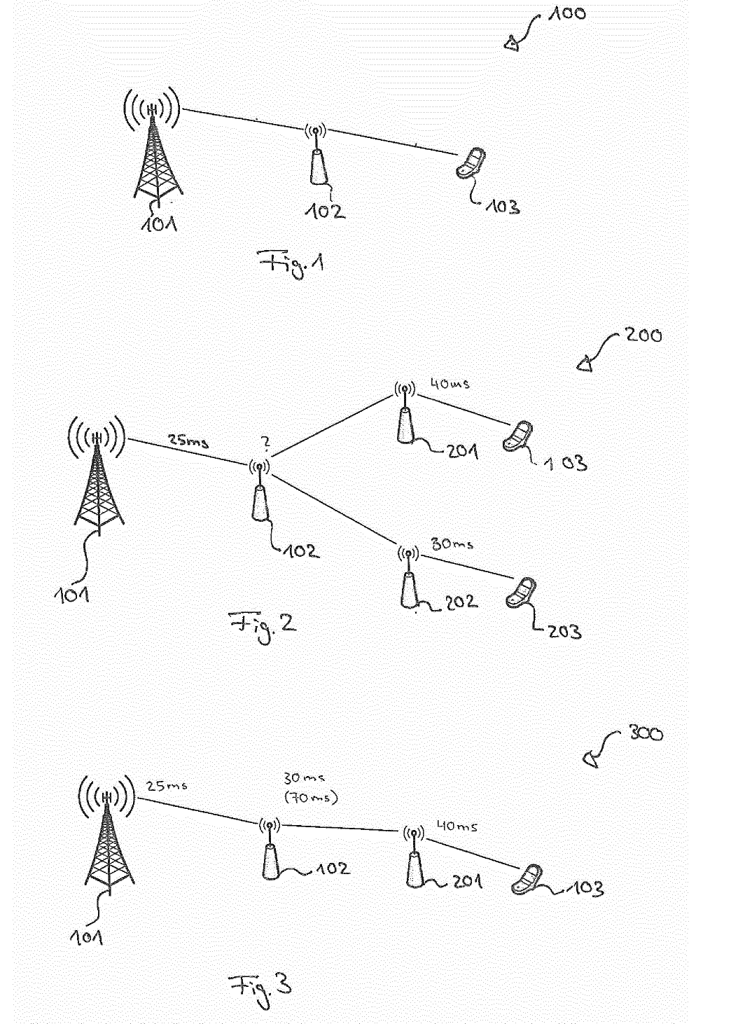

As already explained above, networks, in particular cellular network according to LTE standards, may be arranged by using one or more relay nodes (RNs) as shown in FIG. 1. Here, a network system 100 comprises a base station 101. The base station 101 is adapted to service a user equipment 103. For providing a better or greater network coverage, the communication between the base station 101 and the user equipment 103 can be provided via a relay node 102.

A multi-hop connection (two hops or more) might be burdened with additional transmission delay, compared to a direct connection. Each RN in a multi-hop connection adds delay to an end-to-end packet transmission time. The delay comes from packet processing and scheduling times.

For specific applications, each transmitted packet can be assigned with quality-of-service (QoS) requirements corresponding to the service for which the packet is corresponding to. There are nine classes of QoS, identified in the packet by the QoS class identifier (QCI). The QCI defines setting for the packet delay budget (PDB). Packet delays—in particular for guaranteed bit rate (GBR) traffic—should typically be lower than the PDB specified for a QCI as long as the UE has sufficient radio channel quality. In average 20 ms delay may be assumed in the core network (between base station and policy and charging enforcement functionality (PCEF)). PDB minus the core network delay may be the maximum delay applicable for the radio interface.

For a multi-hop connection, to correctly estimate the delay allowed on a hop of the connection (at the DeNB, nested-RN or an end-RN), it is required to know the delay already used at earlier hops (e.g. at DeNB), the number of further RNs in the connection and the delay that the following RNs will introduce. With the existing standards, there is no possibility for a RN to know the delay already used, nor the knowledge of the further RNs in the connection cannot be always assumed (depends on the architecture).

In the following, a two-hop connection, as depicted in FIG. 1, will be considered. According to the existing standards, for a voice transmission (QCI 1) the PDB is 100 ms. Each node in the connection (DeNB and RN) assumes 20 ms delay in the core, and 80 ms allowed in the radio interface. When the schedulers in both nodes are not coordinated each node can use up to 80 ms delay, resulting in up to 160 ms total delay. The QoS requirements for the packets might not be met.

Therefore, the RN 102 according to this embodiment may provide a control based on delay budget estimations for multi-hop connections. A method for controlling a multi-hop transmission of a data packet between a base station and a user equipment via the relay node may be carried out. A maximum allowable time period for transmitting the data packet between the base station and the user equipment via the at least one relay node is specified, for example based on QoS requirements. The relay node 102 calculates, based on a time information associated with a time period, which has been needed for a transmission of the data packet to the at least one relay node (starting from the base station 101 or the user equipment 103), and the maximum allowable time period, a remaining time period being available for the at least one relay node for transmitting the data packet (to the user equipment or the base station). The RN further controls the transmission of the data packet from the at least one relay node to the base station or the user equipment based on the calculated remaining time period.

In the following, two specific embodiments will be described. In a first embodiment, each packet designed for a multi-hop transmission may be marked with a timestamp showing generation time of the packet. The timestamp could be added for example in the GTP-U header of the packet but of course it could be added to other headers. The timestamp can be used to estimate the delay already experienced on previous relaying hops. Each node, upon reception of a packet, can check the timestamp in the packet header, compare it with the current time and estimate the already experienced delay.

An alternative solution could be to include the delay already cumulated for example in the MAC header (but of course other headers can be used). I.e. after the scheduling decision is taken, it will summed the cumulated delay in the current node to the delay already cumulated in the previous nodes and included for example in the MAC header.

Additionally, it should be known at each stage of the multi-hop connection (i.e. at each RN along the path), how many relaying hops are still coming. This allows estimating what fraction of the remaining maximum delay can be used for each relaying hop. The knowledge of number of relaying hops in a multi-hop connection can be assumed according to the following. For downlink user-terminated transmissions, the DeNB (base station) should have a lookup table coupling target Cell ID with number of hops required to reach a UE at the indicated RN cell. This information could be provided by the RN during the RN start up procedure (the RN receives this information from the RN-OAM). For uplink DeNB-terminated transmissions, each RN may know the number of hops required to reach DeNB (e.g. based on information provided from RN-OAM during RN start up procedure).

The number of remaining hops can be included in the packet and decreased at each intermediate node that is passed. Knowing the real past delay and next relaying hops precise control of the packet scheduling delay can be done.

According to another embodiment, layer-2 (L2) measurement of packet delay may be used. The packet delay is measured by a base station separately for each QCI. The measurements are done for downlink and uplink transmission directions. In case of DeNB, the measurements may be performed separately for the Un and Uu. The measurements are reported to the operation-and-maintenance (OAM) entity.

The L2 packet delay measurements may be exchanged between interconnected nodes, i.e. delay measured at the DeNB on the Un interface should be made available to all RNs connected directly or indirectly (via nested-RNs) to the DeNB, and delay measured at a RN (nested-RN or end-RN) on Un and RN-Uu interfaces should be made available at the DeNB and other RNs connected directly or indirectly (via nested-RNs) to the RN providing the measurements. The information on packet delay on previous and next relaying hops can be used to correctly estimate the maximum delay budget available for the current relaying hop.

Exchanging L2 packet delay measurements may be carried out by using the X2 interface or RRC or MAC signalling. The packet delay measurements exchange over the X2 interface, RRC or MAC can be done very fast and often (on a timescale of milliseconds), thus can be used for dynamic delay control. Alternatively, the delay measurements could be provided from the OAM to all the interested nodes.

In Rel. 10, it is assumed that the RN-OAM provides to a RN during the start up phases the list of DeNB cells that the RN is allowed to connect. This can be extended also in case of multi-hop where it may be assumed that the RN-OAM knows the cells the RN is allowed to connect and these can be “real” DeNB cells or nested RN cells. Furthermore, it may be assumed that the RN-OAM provides delay estimation associated to each cell, this can be in number of hops to/from the DeNB or based on L2 delay measurements reported by the DeNB and nested RNs to the OAM.

In the first embodiment, the base station 101 or user equipment 103 generates a packet (source node). This node marks the packet with a timestamp holding the generation time, executes the delay budget calculation

$$MaxDelay = \frac{PDB - 20 ms}{NumHops} ,$$

where MaxDelay is the maximum delay available for a single hop and NumHops is the number of transmission hops to go. Further, the node tries to send the packet before the MaxDelay time.

Each RN 102 in the multi-hop connection executes a delay budget calculation

$$MaxDelay = \frac{PDB - 20 ms - ( Time - GenTime )}{NumHops} ,$$

where Time is the current time and GenTime is the time of the packet generation. If the calculated MaxDelay is below a certain threshold—the estimated minimum delay introduced by the node, it can be assumed that the remaining time for transmission is not sufficient to deliver the packet within the QoS requirements, thus the packet can be dropped. If the calculated MaxDelay is above the estimated minimum delay introduced by the node, the node tries to send the packet before the MaxDelay time.

In the second embodiment, all nodes (DeNB, nested-RNs and end-RNs) collect packet delay measurements from all subordinate and superior nodes and sum them to estimate delay for each subordinating connection (future delay) and for the preceding connection (previous delay).

FIG. 2 shows an example of such a network configuration. The delay between the DeNB 101 and the nested RN 102 may be for example 25 ms. The nested RN estimates this delay as previous delay. It further estimates the delay to RN 201 for example as 40 ms and the delay to RN 202 as 30 ms. Thus, a maximum delay for packets to user equipment 103 may be PDB-20-25-40 [ms] and to user equipment 203 PDB-20-25-30 [ms].

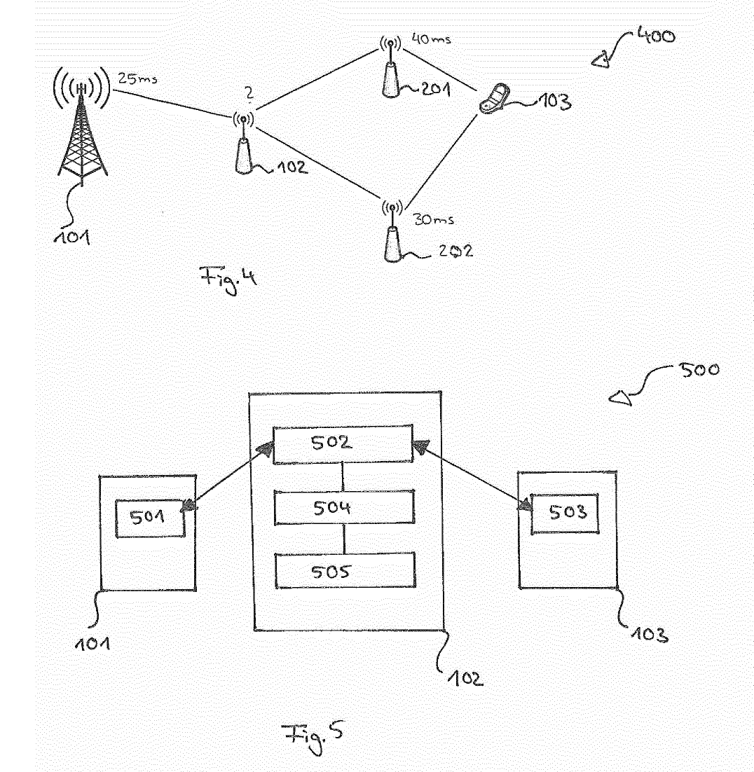

Depending on the nested-RN functionalities, it could be also possible that the nested-RN can calculate the sum of its own delay measurement and the delay of subordinate RNs, and forward it as the total delay in the part of the network topology supported by the nested-RN. For example as shown in FIG. 3, the nested RN 102 may report a total delay for the shown part of the network topology (i.e. RN 102 to RN 201 to UE 103).

In case of a cooperative operation (e.g. incorporating joint processing CoMP) the delays for links to all nodes taking part in the cooperation should be considered and the highest one used for the delay estimations, as for example shown in FIG. 4. The nested RN 102 may estimated a previous delay at the DeNB 101 of 25 ms. It may further estimate a next delay to RN 201 of 40 ms and to RN 202 of 30 ms. Thus, it may determine a maximum delay via RN 201 of PDB-20-25-40 [ms] and a maximum delay via RN 202 of PDB-20-25-30 [ms]. The estimated past and future delays are subtracted from the PDB specified by the packet QCI to estimate the available delay for the current relaying hop. If the result of the subtraction is positive, the packet scheduler tries to forward the packet within the estimated delay time. If the result of the estimation is negative, the packet can be dropped, as it will not be delivered in the required maximum delay time (delay on the next hops is higher than the remaining allowed delay time). Additionally, if a packet is dropped because of too high delay, a request of lower scheduling delay for the QCI on the multi-hop connection can be send to the preceding nodes. This can be done also over the X2 interface.

The previous implementation details are presented for the downlink but it can be applied in the same way also in the uplink. One advantage of the proposed procedures is that a QoS satisfaction rate can be increased by coordinating retransmission delay for multi-hop transmission. Further, if it is detected that a packet cannot reach the recipient in the required time, the packet can be dropped, thus radio resources might not be wasted.

FIG. 5 shows a network system 500 according to an exemplary embodiment of the invention. The network system comprises a base station 101, a relay node 102 and a user equipment 103.

A relay node 102 according to this embodiment may be a base station not having a fixed connection to the operator's core network (backhaul). The backhaul connection may be provided to them over radio interface from a standalone (i.e. having a fixed backhaul) base station (donor node, DeNB). The RN can be either a stationary device (e.g. installed on a lamppost), or a mobile device (e.g. installed in a bus, train). The basic use case for RNs is providing low cost network coverage extension and coverage improvement in areas not suitable for typical base station deployments (e.g. due to cost and/or difficulties of providing fixed backhaul).

The relay node comprises a receiving unit, for example a receiver as known by a skilled person. The relay node also comprises a transmitting unit, for example a transmitter. The receiver and the transmitter may be implemented as one single unit, for example as a transceiver 502. The transceiver or the receiving unit and the transmitting unit may be adapted to communicate with a further relay node, a base station or the user equipment via an antenna.

The relay node comprises further a calculation unit 504 being adapted to calculate, based on a time information associated with a time period, which has been needed for a transmission of the data packet to the at least one relay node, and the maximum allowable time period, a remaining time period being available for the at least one relay node for transmitting the data packet. The relay node comprises also a control unit 505 for controlling the transmission of the data packet from the at least one relay node to the base station or the user equipment based on the calculated remaining time period.

The control unit and the calculation unit may be implemented as single units or may be one unit being implemented for example as part of a standard control unit, like a CPU or a microcontroller.

The base station 101 may be any type of access point or point of attachment, which is capable of providing a wireless access to a cellular network system. Thereby, the wireless access may be provided for a user equipment, a relay node or for any other network element, which is capable of communicating in a wireless manner. The base station may be an eNodeB, eNB, home NodeB or HNB, or any other kind of access point.

The base station may comprise a receiving unit, for example a receiver as known by a skilled person. The base station may also comprise a transmitting unit, for example a transmitter. The receiver and the transmitter may be implemented as one single unit, for example as a transceiver 501. The transceiver or the receiving unit and the transmitting unit may be adapted to communicate with the relay node via an antenna.

A user equipment (UE) 103 in the context of this description may be any type of communication end device, which is capable of connecting with the described relay node. The UE may be in particular a cellular mobile phone, a Personal Digital Assistant (PDA), a notebook computer, a printer and/or any other movable communication device.

The user equipment may comprise a receiving unit or receiver which is adapted for receiving signals from the relay node.

The user equipment may further comprise a transmitting unit for transmitting signal. The transmitting unit may be a transmitter as known by a skilled person. The receiver and the transmitting unit may be implemented as one single unit, for example as a transceiver 503. The transceiver or the receiver and the transmitting unit may be adapted to communicate with the relay node via an antenna.

Having regard to the subject matter disclosed herein, it should be mentioned that, although some embodiments refer to a “base station”, “eNB”, relay node, etc., it should be understood that each of these references is considered to implicitly disclose a respective reference to the general term “network component” or, in still other embodiments, to the term “network access node”. Also other terms which relate to specific standards or specific communication techniques are considered to implicitly disclose the respective general term with the desired functionality.

It should further be noted that a relay node as disclosed herein is not limited to dedicated entities as described in some embodiments. Rather, the herein disclosed subject matter may be implemented in various ways in various locations in the communication network while still providing the desired functionality.

According to embodiments of the invention, any suitable entity (e.g. components, units and devices) disclosed herein, e.g. the calculation unit, are at least in part provided in the form of respective computer programs which enable a processor device to provide the functionality of the respective entities as disclosed herein. According to other embodiments, any suitable entity disclosed herein may be provided in hardware. According to other—hybrid—embodiments, some entities may be provided in software while other entities are provided in hardware.

It should be noted that any entity disclosed herein (e.g. components, units and devices) are not limited to a dedicated entity as described in some embodiments. Rather, the herein disclosed subject matter may be implemented in various ways and with various granularity on device level while still providing the desired functionality. Further, it should be noted that according to embodiments a separate entity (e.g. a software module, a hardware module or a hybrid module) may be provided for each of the functions disclosed herein. According to other embodiments, an entity (e.g. a software module, a hardware module or a hybrid module (combined software/hardware module)) is configured for providing two or more functions as disclosed herein.

It should be noted that the term “comprising” does not exclude other elements or steps. It may also be possible in further refinements of the invention to combine features from different embodiments described herein above. It should also be noted that reference signs in the claims should not be construed as limiting the scope of the claims.

### LIST OF REFERENCE SIGNS

100 Network system
101 Base station
102 Relay node
103 User equipment
200 Network system
201 Relay node
202 Relay node
203 User equipment
300 Network system
400 Network system
500 Network system
501 Transceiver of base station
502 Transceiver of relay node
503 Transceiver of user equipment
504 Calculation unit of relay node
505 Control unit of relay node

1. A method for controlling a multi-hop transmission of a data packet between a base station and a user equipment via at least one relay node,
wherein a maximum allowable time period for transmitting the data packet between the base station and the user equipment via the at least one relay node is specified, the method comprising
calculating, based on a time information associated with a time period, which has been needed for a transmission of the data packet to the at least one relay node, and the maximum allowable time period, a remaining time period being available for the at least one relay node for transmitting the data packet, and
controlling the transmission of the data packet from the at least one relay node to the base station or the user equipment based on the calculated remaining time period.

2. The method as set forth in claim 1, wherein calculating the remaining time period being available for the at least one relay node for transmitting the data packet is further based on a time information associated with a predicted time period, which will be needed for a transmission of the data packet starting from the at least one relay node.

3. The method as set forth in claim 1, wherein
the maximum allowable time period for transmitting the data packet between the base station and the user equipment via the at least one relay node is specified based on quality of service requirements.

4. The method as set forth in claim 1, wherein controlling the transmission of the data packet from the at least one relay node to the base station or the user equipment comprises
estimating a needed time period for transmitting the data packet to the base station or the user equipment, and
determining whether the needed time period is less than or equal to the calculated remaining time period.

5. The method as set forth in claim 4, wherein controlling the transmission of the data packet from the at least one relay node to the base station or the user equipment comprises
dropping the data packet when the needed time period is greater than the calculated remaining time period.

6. The method as set forth in claim 1, the method further comprising
determining the time information associated with a time period, which has been needed for transmission of the data packet to the at least one relay node, based on a timestamp being comprised in the data packet.

7. The method as set forth in claim 6,
wherein the timestamp is indicative of a generation time of the data packet, and
wherein determining the time information comprises
comparing the timestamp with an actual time, and
calculating the time period, which has been needed for transmission of the data packet to the at least one relay node based on this comparison.

8. The method as set forth in claim 6,
the method further comprising
determining a predicted time period, which will be needed for transmission of the data packet starting from the at least one relay node, based on overall network information being provided to the relay node during start of the relay node,
wherein calculating the remaining time period being available for the at least one relay node for transmitting the data packet is further based on a time information associated with the predicted time period.

9. The method as set forth in claim 1, the method further comprising
determining the time information associated with a time period, which has been needed for transmission of the data packet to the at least one relay node, based on predetermined transmission time information being exchanged between the at least one relay node and the base station.

10. The method as set forth in claim 9,
the method further comprising
determining a predicted time period, which will be needed for a transmission of the data packet starting from the at least one relay node, based on a predetermined transmission time information being exchanged between the at least one relay node and the base station,
wherein calculating the remaining time period being available for the at least one relay node for transmitting the data packet is further based on a time information associated with the predicted time period.

11. The method as set forth in claim 9,
wherein determining the time information associated with a time period, which has been needed for a transmission of the data packet to the at least one relay node, and/or determining the predicted time period comprises
exchanging packet delay measurements between the base station and the at least one relay node.

12. The method as set forth in claim 11, wherein
exchanging packet delay measurements comprises exchanging information via an X2 interface.

13. The method as set forth in claim 11, wherein
exchanging packet delay measurements comprises exchanging information using radio resource control signalling and/or medium access control signalling.

14. A relay node being adapted for controlling a multi-hop transmission of a data packet between a base station and a user equipment via the at least one relay node,
wherein a maximum allowable time period for transmitting the data packet between the base station and the user equipment via the at least one relay node is specified, the relay node comprising
a calculation unit being adapted to calculate, based on a time information associated with a time period, which has been needed for a transmission of the data packet to the at least one relay node, and the maximum allowable time period, a remaining time period being available for the at least one relay node for transmitting the data packet, and
a control unit for controlling the transmission of the data packet from the at least one relay node to the base station or the user equipment based on the calculated remaining time period.

15. A network system for controlling a multi-hop transmission of a data packet between a base station and a user equipment via at least one relay node, the network system comprising at least one relay node as set forth in claim 14.
